(19) United States
(12) Patent Application Publication
(10) Pub. No.: US 2011/0213718 A1
(43) Pub. Date: Sep. 1, 2011

(54) FLOOR COVERING ESTIMATOR AND ASSOCIATED METHOD

(75) Inventor: Steven Paul Leger, Ringgold, GA (US)

(73) Assignee: Mohawk Carpet Distribution, Inc.

(21) Appl. No.: 12/891,359

(22) Filed: Sep. 27, 2010

Related U.S. Application Data
(60) Provisional application No. 61/245,924, filed on Sep. 25, 2009.

(51) Int. Cl. G06Q 99/00

(52) U.S. Cl. 705/306

(57) ABSTRACT

Various embodiments of the present invention provide tools for assessing damaged floor coverings to determine LKQ replacement values and face weights for carpet. In one embodiment, a method is provided that includes the steps of determining a yarn price constant for a plurality of carpet types, where the yarn price constant represents the price of a single tuft of yarn for a respective carpet type measured at a predetermined pile height and receiving, from a user, data relating to the damaged carpet's construction. The data may further include the damaged carpet's pile height and stitch density. Using a computing device, the yarn type of the damaged carpet is estimated based at least in part on the received data relating to the damaged carpet's construction. A database may then be queried with at least a portion of the data received to retrieve an associated yarn price constant and an LKQ replacement value calculated by multiplying the received damaged carpet's pile height and stitch density with the associated yarn price constant.

### CROSS-REFERENCE TO RELATED APPLICATIONS

This application claims priority to U.S. Provisional Application No. 61/245,924 filed Sep. 25, 2009, which is incorporated herein in its entirety by reference.

### BACKGROUND OF THE INVENTION

Insurance companies spend approximately $25 billion in total products and services for claims and restoration for losses to structures and contents of the structures in both commercial and residential settings. More than 2,000 times a day, homeowners file property damage claims that involve floor coverings. As a result, it is estimated that insurers routinely pay out more than $5 billion annually replacing damaged floor coverings resulting from fire, water damage and other household perils. Floor coverings are the second most expensive building component for an insurance carrier—second only to roofing. In order to prepare appropriate loss payments to the insured for replacement flooring, adjusters are challenged with determining the current market value of a similar carpet type.

The claim process itself is composed of a series of events that culminate in a settlement with the policyholder. The settlement, per the terms of the insurance policy, is the primary goal of the adjuster and represents a lessened cost exposure to the carrier if the settlement is reached quickly with minimal disputes. The first event is that of claim notification. The policyholder contacts the carrier via a call center or agent and files a claim. The carrier is then obligated to validate the policy and assess the claim to determine if it is a covered loss. If the loss is covered, the adjuster assigned to the loss develops a cost estimate of labor and materials to return the property to pre-loss condition. This includes taking into consideration physical depreciation schedules where applicable. The adjuster then presents the settlement to the policyholder with hopes of gaining acceptance, preparing the payment and closing the file.

In terms of residential flooring losses, water damage leads the list. 70% of all homeowner claims include damage to flooring due to water pipe breaks, sump pump failures and weather. In those events, the carrier urges the homeowner to contact a local emergency response vendor to come to the site immediately to control further damage and begin a drying process to hopefully save the floor covering and other materials like drywall and the contents of the structure. If the floor covering is found to be too badly damaged and has to be replaced, the adjuster moves on to phase two of the job that includes “like kind and quality” (“LKQ”) identification, pricing, settlement and payment. In the insurance claims industry, the acronym “LKQ” is used to describe a product or material that is similar in appearance, quality and value to that which is being replaced after suffering damage or total loss. LKQ is a determinant of value to ensure the policyholder will receive appropriate indemnity for that which they have lost.

The job of the adjuster is to determine the LKQ of the damaged product requiring replacement and to arrive at a settlement price. Since most homeowner policies categorize wall-to-wall floor covering as part of the structure, the material itself is not usually subject to a depreciation schedule for replacement cost calculations. Conversely, the settlement for the flooring material is typically based on a current market replacement cost (Replacement Cost Value). There is usually no consideration for the age of the material, manufacturer or what the homeowner originally paid. In essence, the adjuster is simply trying to determine if the damaged carpet is equivalent to a new $5 per yard carpet or a new $100 per yard carpet. Most carriers simply rely on their adjusters to make a subjective opinion without assistance from any tool or reference source. This often results in over payment by the carrier or underpayment by the carrier coupled with a dissatisfied customer.

Some carriers utilize the services of a specialized laboratory to help them determine LKQ and an appropriate retail price. In this process, the adjuster will fill out a request form by hand, cut out a piece of the damaged carpet and mail it to the lab. This process, however, can be expensive and can take up to 2 days to obtain the results. Accordingly, a need existed for systems and methods that can better determine an LKQ for a floor covering.

### BRIEF SUMMARY OF THE INVENTION

Various embodiments of the present invention provide innovative systems and method for estimating the replacement cost of flooring. In one aspect of the invention, a method for calculating the LKQ replacement value for a damaged carpet is provided. This method includes the steps of: determining a yarn price constant for a plurality of carpet types, wherein the yarn price constant represents the price of a single tuft of yarn for a respective carpet type measured at a predetermined pile height; receiving, from a user data relating to the damaged carpet's construction, and the damaged carpet's pile height and stitch density; estimating, using a computing device, the yarn type of the damaged carpet based at least in part on the received data relating to the damaged carpet's construction; querying a database, using the computing device, with at least a portion of the data received to retrieve an associated yarn price constant; and calculating an LKQ replacement value, using a computing device, by multiplying the received damaged carpet's pile height and stitch density with the associated yarn price constant.

In another aspect of the invention, a system for estimating the cost of replacement flooring is provided. This system includes one or more processors in communication with one or more data storage devices, wherein the one or more processors programmed to: determine a yarn price constant for a plurality of carpet types, wherein the yarn price constant represents the price of a single tuft of yarn for a respective carpet type measured at a predetermined pile height; receive, from a user data relating to the damaged carpet's construction, and the damaged carpet's pile height and stitch density; estimate the yarn type of the damaged carpet based at least in part on the received data relating to the damaged carpet's construction; query the one or more data storage devices with at least a portion of the data received to retrieve an associated yarn price constant; and calculate an LKQ replacement value, using a computing device, by multiplying the received damaged carpet's pile height and stitch density with the associated yarn price constant.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of an Estimator System 10 in accordance with an embodiment of the present invention.

FIG. 2 is a schematic diagram of an Estimator Server 40 in accordance with an embodiment of the present invention.

FIG. 3 is a flow diagram illustrating steps in accordance with an embodiment of the present invention.

FIG. 4 is a pictorial view of a custom ruler that may be used in accordance with an embodiment of the present invention.

FIGS. 5-22 are screen shots depicting the steps followed by a user in determining the LKQ replacement value and face weight using an embodiment of the present invention.

FIG. 23 is a pictorial view of a carpet guide 20 in accordance with an embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Various embodiments of the present invention provide tools for assessing damaged floor coverings to determine LKQ replacement values and face weights for carpet. These tools may be useful to property insurance adjusters and/or restoration specialists. A benefit of this system is that it may be used at the site of the loss. In various embodiments, the associated process includes an empirical analysis of the damaged flooring using a visual and tactile evaluation coupled with a web-based estimator system.

Embodiments of the present invention may be used to aid insurance carriers in adjudicating settlements faster with appropriate accuracy and economy while achieving greater policyholder satisfaction and limiting file settlement liability. Additionally, each time an assessment is conducted to produce an LKQ report, the resultant report may include targeted advertising for a participating local flooring retailer that the homeowner is invited to use to acquire the flooring they need. As a result, the customer is provided a potential source for replacement flooring, and the flooring retailer has the opportunity to market to a customer in need of its products. The list of retailers may be limited to “preferred” vendors, such as those that meet a predetermined service and/or pricing criteria. The following paragraphs describe various aspects of the invention in the context of replacing damaged or used carpet. However, as will be understood by those of ordinary skill in the art, the concepts described herein may be used to estimate other types of floor coverings including tile, wood, composite flooring, and vinyl.

System Architecture

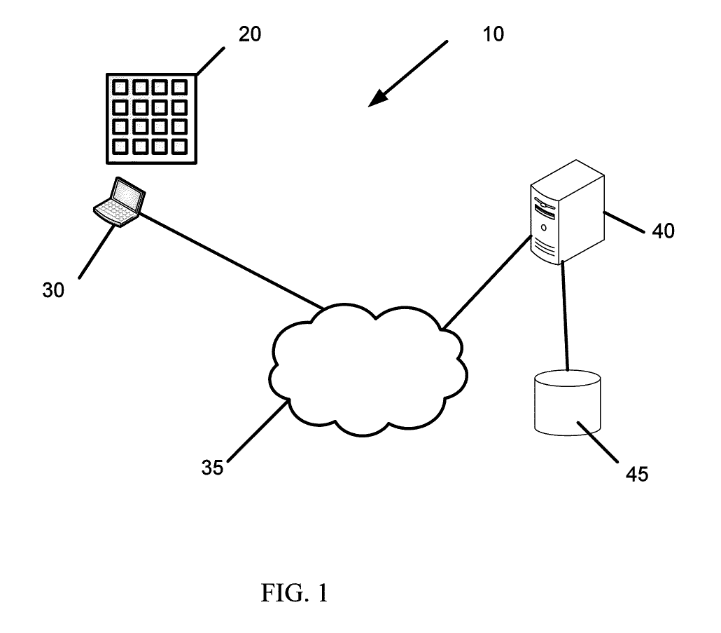

FIG. 1 shows a block diagram of an Estimator System 10 in accordance with an embodiment of the present invention. As may be understood from this figure, the Estimator System 10 includes a carpet guide 20, a client computer 30, an Estimator Server 40, and a relational database 45. In various embodiments, the system 10 further includes one or more networks 35, such as a LAN or a global communications network (e.g., the Internet) for facilitating communication between one or more of the system's various components. In one embodiment of the invention, the Estimator Server 40 is configured for retrieving data from, and for saving data to, the relational database 45. In various embodiments, the relational database 45 is a Microsoft® SQL Server database; however, as will be understood by those of ordinary skill in the art, other types of databases may be used in connection with embodiments of the present invention.

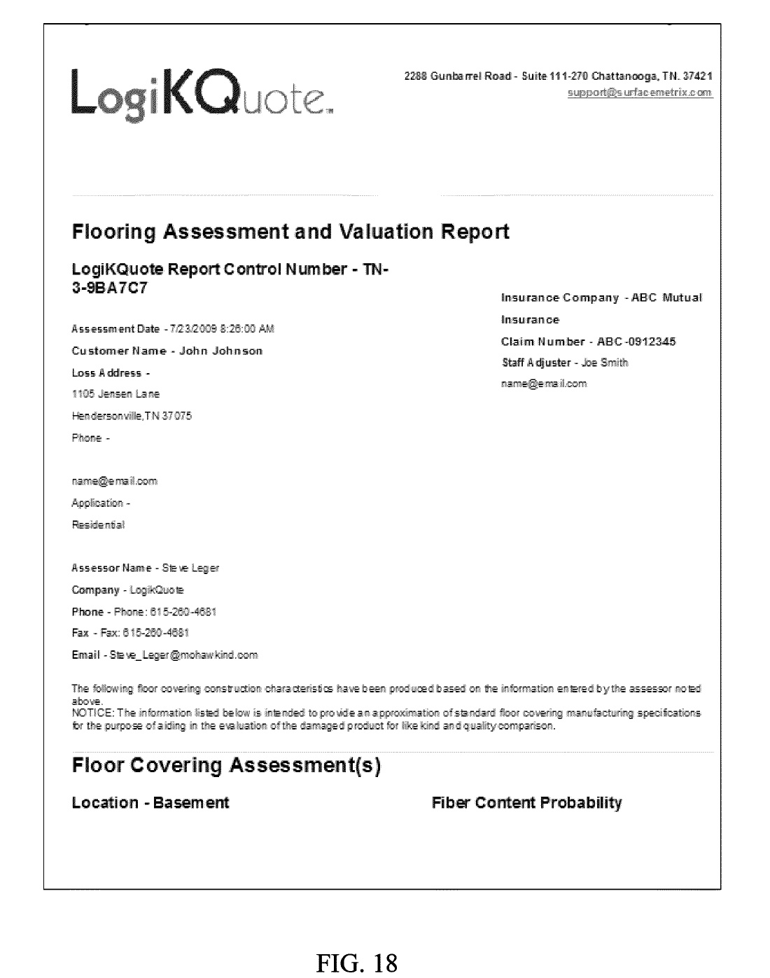

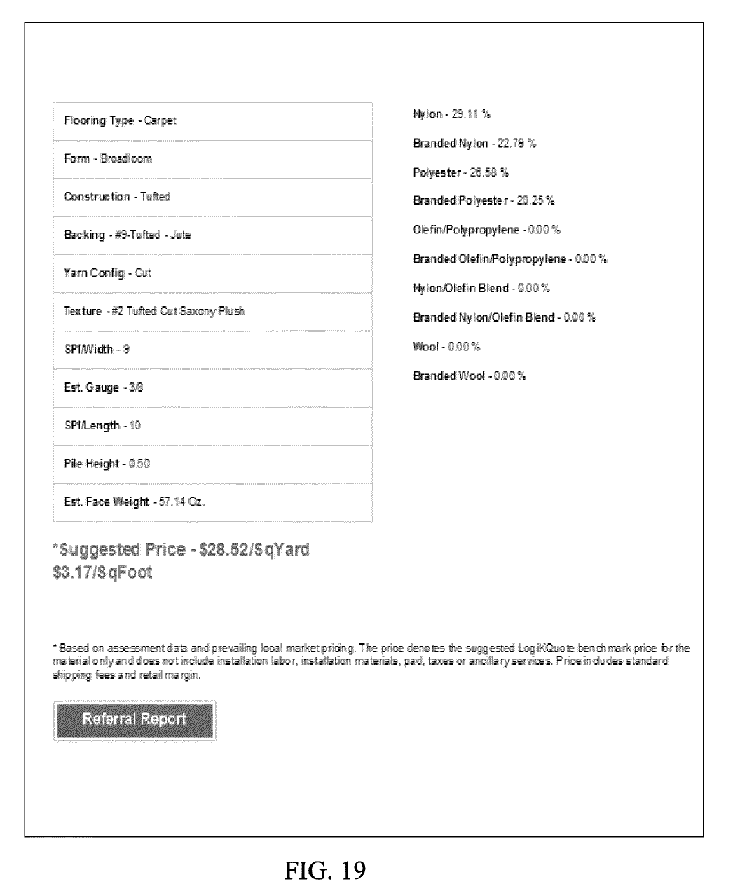

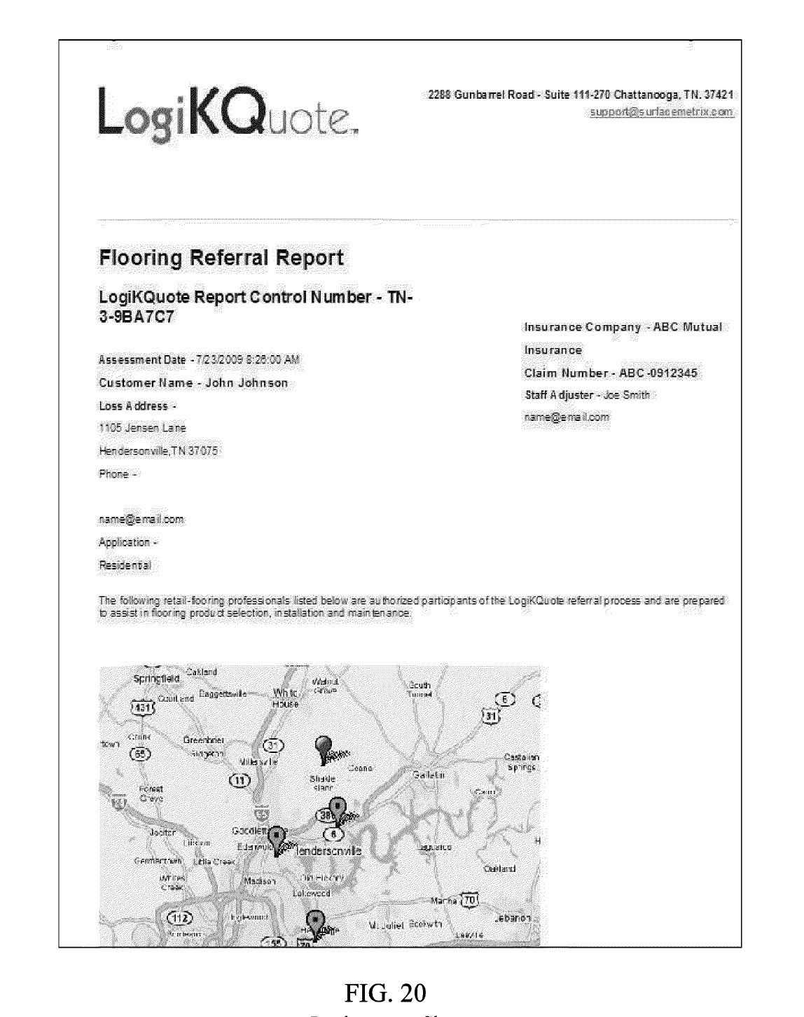

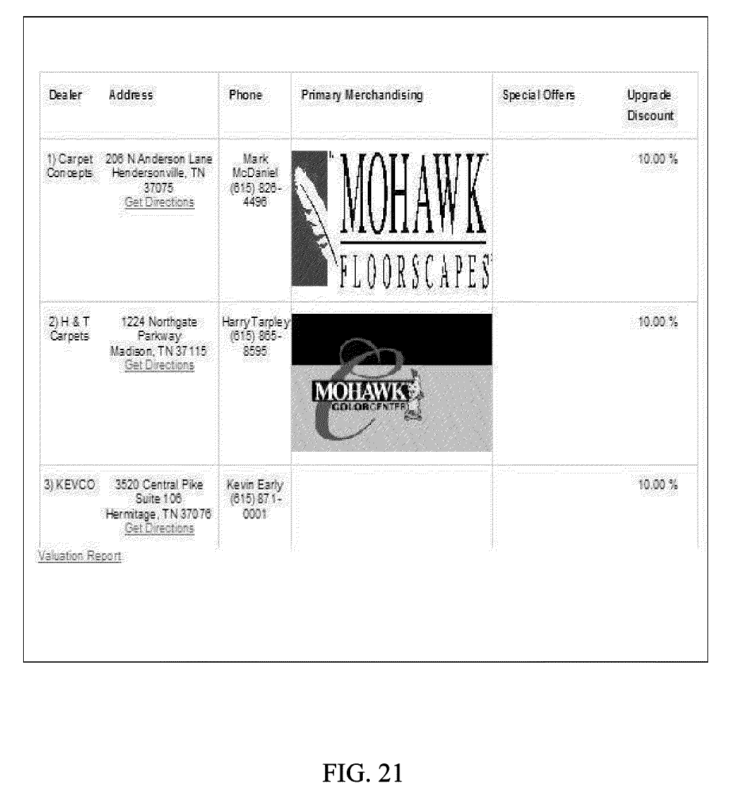

Generally described, a user enters data relating to various parameters of a damaged floor covering into the Estimator System 10 using the client computer 30. The client computer 30 communicates the data through the network 35 to the Estimator Server 40. The Estimator Server 40 uses the entered data in connection with the relational database 45 to determine an LKQ replacement value and face weight associated with the damaged carpet, which may then be communicated to the user through the client computer 30. A report may then be generated that indicates the determined carpet type, various parameters of the carpet and a price per yard. The report may also provide a list of retailers willing to sell the identified carpet at the identified price. FIGS. 18-21 illustrate a report generated by an embodiment of the present invention.

In various embodiments, the carpet guide 20 comprises one or more physical binders with a series of swatches or pictures that represent industry-standard carpet categories. Although there are more than 5,000 unique-named carpet styles found in common carpet stores, these named carpet styles have similarities that allow them to be placed into broad categories or types. Generally, carpet styles within a carpet type may have the same construction (e.g., woven or tufted), carpet backing, pile configuration, yarn type and texture type.

A benefit of the physical carpet guide 20 is that a user may use both visual and tactile comparisons to identify an appropriate match. It should be understood, however, that in some embodiments the carpet guide 20 may comprise a series of images displayed on a computer screen or in a physical folder.

In one embodiment, the carpet guide 20 includes three “reference folders” containing floor covering swatches and carpet backing swatches. The swatches may be selectively secured in the folders using hook and loop type fastening, pressure sensitive adhesives or other releasable attachment techniques. The releasable feature of these swatches can facilitate style updates as necessary. In other embodiments, the swatches may be permanently secured within the folders.

In various embodiments, the types of swatches or images provided in the carpet guide 20 may be divided into two categories—backing styles and texture types. The backing styles may include samples of the common carpet backing materials used for residential and commercial carpeting. Similarly, the texture types may include samples of the various types of carpet textures available. Each of the texture types may represent an industry-standard carpet category. Examples of texture types include tufted saxony, frieze, and textured loop. Within each of those families, there may be a more detailed sub-classification for yarn density, pile height, and pile weight. These characteristics may have a bearing on the actual manufacturing cost and resultant retail price of the carpet.

The client computer 30 may be any type of electronic device capable of displaying, receiving and transmitting data. In various embodiments, the client computer 30 is a laptop, portable, or desktop computer. In other embodiments, the client computer 30 may be a PDA, cellular phone or other handheld electronic device.

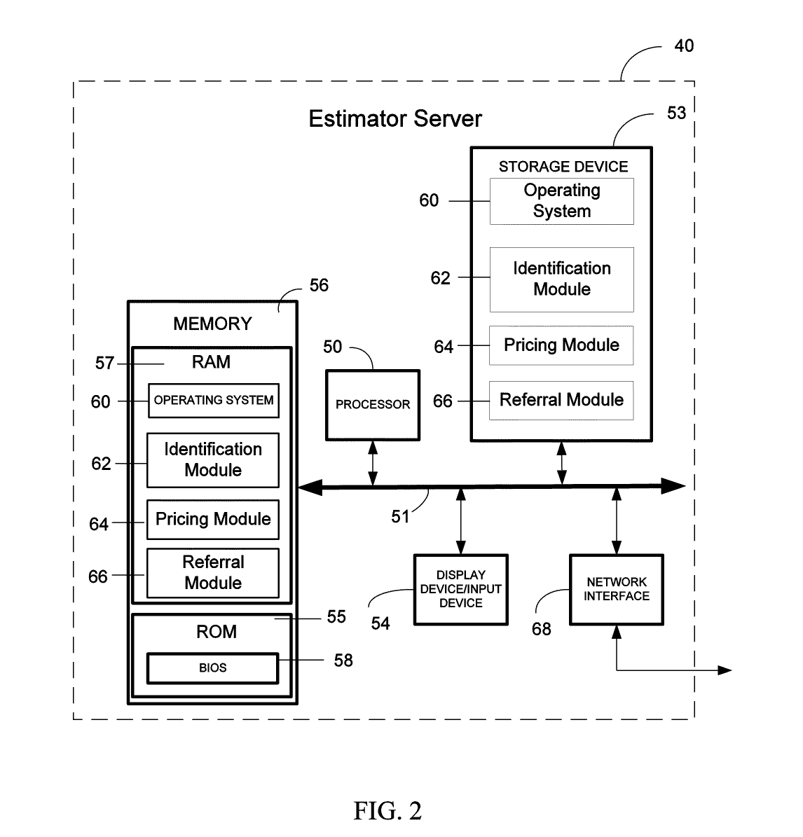

FIG. 2 shows a schematic diagram of an Estimator Server 40 according to one embodiment of the present invention. As may be understood from this figure, the Estimator Server 40 includes a processor 50 that communicates with other elements within the Estimator Server 40 via a system interface or bus 51. Also included in the Estimator Server 40 is a display device/input device 54 for receiving and displaying data. This display device/input device 54 may be, for example, a keyboard or pointing device that is used in combination with a monitor. The Estimator Server 40 further includes memory 56, which preferably includes both read only memory (ROM) 55 and random access memory (RAM) 57. The server's ROM 65 is used to store a basic input/output system 58 (BIOS), containing the basic routines that help to transfer information between elements within the Estimator Server 40.

In addition, the Estimator Server 40 includes at least one storage device 53, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 53 is connected to the system bus 51 by an appropriate interface. The storage devices 53 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 57. Such program modules include an operating system 60, an Identification Module 62, a Pricing Module 64 and a Referral Module 66 that control certain aspects of the operation of the Estimator Server 40, with the assistance of the processor 50 and the operating system 60.

Also located within the Estimator Server 40 is a network interface 68 for interfacing and communicating with other elements of a computer network. It will be appreciated by one of ordinary skill in the art that one or more of the Estimator Server 40 components may be located geographically remotely from other Estimator Server 40 components. Furthermore, one or more of the components may be combined, and additional components performing functions described herein may be included in the Estimator Server 40.

The Identification Module 62 prompts a user to enter specific data regarding the damaged carpet for which an LKQ replacement value and face weight is desired. The information requested may relate to the style of the damaged carpet. For example, the Identification Module 62 may prompt the user to identify a construction type, a pile configuration, and a texture type of the damaged carpet. To facilitate proper identification of the various carpet parameters, the Identification Module 62 may provide digital images of the different carpet types and prompt the user to select the image that most closely matches the damaged carpet. In other embodiments, the user may be prompted to use the carpet guide 20 to identify a match for a particular parameter. The Identification Module 62 may provide a list or drop down menu of the available options listed by name or identification code from which the user is asked to select from. In further embodiments, the user may identify the appropriate code from the carpet guide 20 and enter the code into the Identification Module 62. In further embodiments, the carpet guide 20 may include barcodes associated with each of the various swatches, and a user could scan the barcode to register a selection.

The Identification Module 62 may also prompt the user to enter physical parameters of the damaged carpet. In various embodiments, the Identification Module 62 prompts the user to enter data regarding the density of the stitches and the pile height. To facilitate the collection of this data, the Identification Module 62 may provide detailed instructions on how to collect the desired information with digital illustrations or digital video.

Once the carpet data has been received, the Identification Module 62 estimates the type of yarn most likely to be present in the damaged carpet. This may be performed using a probability analysis based on manufacturing statistics. For example, tufted cut-saxony carpets are made of Nylon 87.4% of the time with the remainder being Polyester. If a tufted cut-saxony carpet is identified, Nylon would be used in subsequent calculations due to its high probability.

In some embodiments, the Identification Module 62 will prompt the user to send the carpet to a laboratory in the event the selection meets predetermined criteria. For example, wool is the most expensive fiber used in the construction of carpet and only represents 2% of all carpets manufactured. In the event wool is identified based on the information received from the user, the Identification Module 62 may instruct the user to send a sample of the damaged carpet to a laboratory for a detailed evaluation to confirm the carpet type identification.

The Pricing Module 64 uses the data collected by the Identification Module 62 and calculates an LKQ replacement value and face weight for the associated damaged carpet. In various embodiments, the Pricing Module 64 uses the carpet construction, backing style, pile configuration and texture type data gathered by the Identification Module 62 to query the relational database 45 to retrieve an appropriate Yarn Weight Constant and a Yarn Price Constant based on the input gathered.

The Yarn Weight Constant represents the weight of a single tuft of yarn of a specific carpet type measured at a pile height of one inch. This constant may be calculated based on statistical averages of various parameters of particular carpet types. In various embodiments, the parameters include pile height, stitch densities (stitches per square inch or yard), and face weights. The Yarn Weight Constant equals the average face weight for the carpet styles within a given carpet type divided by the average stitch density and the average pile height for the same carpet styles.

The Yarn Price Constant represents the wholesale cost of a single tuft of yarn of a specific carpet type measured at a pile height of one inch. Similar to the Yarn Weight Constant, the Yarn Price Constant is calculated based on various carpet parameters including pile height and stitch densities (stitches per square inch). In various embodiments, the Yarn Price Constant equals the average wholesale price of the carpet styles within a carpet type divided by the average stitch density and the average pile height of the carpet styles within that carpet type. As will be understood by those of skill in the art, the Yarn Price Constant may differ between different geographic regions or areas. Accordingly, the Pricing Module 64 may take into account the location of the damaged carpet when querying the relational database 45 to identify the Yarn Price Constant. In various embodiments, these two constants are calculated to twenty positions to the right of the decimal.

For example, there are approximately 300 unique carpet styles of the carpet type “tufted cut pile saxony.” Each of these styles may be uniquely constructed in terms of pile height (PH), stitches per inch/width (SPIW), and stitches per inch/length (SPIL). The calculation of a Yarn Weight Constant and a Yarn Price Constant for the tufted cut pile saxony carpet type may be calculated by averaging the pile height, stitch densities, face weights and wholesale prices of these 300 styles and applying the following model:

$$Average Stitches per sq . in . = Average SPIW \times Average SPIL$$

$$Average Stitches per sq . yd . = Average stitches per square inch \times 1296$$

$$Yarn Weight Constant = \frac{Ave . Face Weight per sq . yd .}{( Ave . Stitches per sq . yd . ) ( Ave . Pile Height ) }$$

$$Yarn Price Constant = \frac{Ave . Wholesale Price}{( Ave . Stitches per sq . yd . ) ( Ave . Pile Height )}$$

In various embodiments, the Yarn Weight Constants and the Yarn Price Constants are calculated periodically and the relational database 45 is updated accordingly. In other embodiments, data for the various styles of carpet are updated periodically and the Pricing Module 64 gathers this data from the relational database 45 and calculates the constants as needed.

The LKQ face weight for the associated damaged carpet may be calculated using the Yarn Weight Constant determined for the identified carpet type as well as the stitch density and pile height that were gathered by the Identification Module 62. The LKQ face weight is calculated as follows:

Stitch Density=(Stitches per inch width)*(Stitches per inch length)*(1296 sq in/sqyd)

LKQ Face Weight=(Stitch Density)*(Pile Height)*(Yarn Weight Constant)

The LKQ replacement value for the associated damaged carpet may be calculated using the Yarn Price Constant determined for the identified carpet type as well as the stitch density and pile height that were gathered by the Identification Module 62. The LKQ replacement value is calculated as follows:

Base Wholesale Price per sq. yd.=(Stitch Density)*(Yarn Price Constant)*(Pile Height)

LKQ Replacement Value=(Base Wholesale Price)*(Typ. Retail Margin)

In various embodiments, the Referral Module 66 identifies one or more retailers that can supply replacement carpet. In various embodiments, the relational database 45 includes a group of retailers meeting predetermined criteria such as quality of service and pricing thresholds. The Referral Module 66 may access this list of retailers in the relational database 45 and identify those within a distance threshold of the customer's address (e.g., same city, zip code, within mileage threshold). This list of identified retailers may be reproduced on the settlement document LKQ report or otherwise provided to the customer.

The Referral Module 66 may include a GoogleMaps™ plug-in to aid in identifying the latitude/longitude of potential retailers. In various embodiments, physical retail locations participating in the referral base may have their addresses converted to latitude/longitude coordinates and may be stored in the relational database 45.

Methods for Determining LKQ

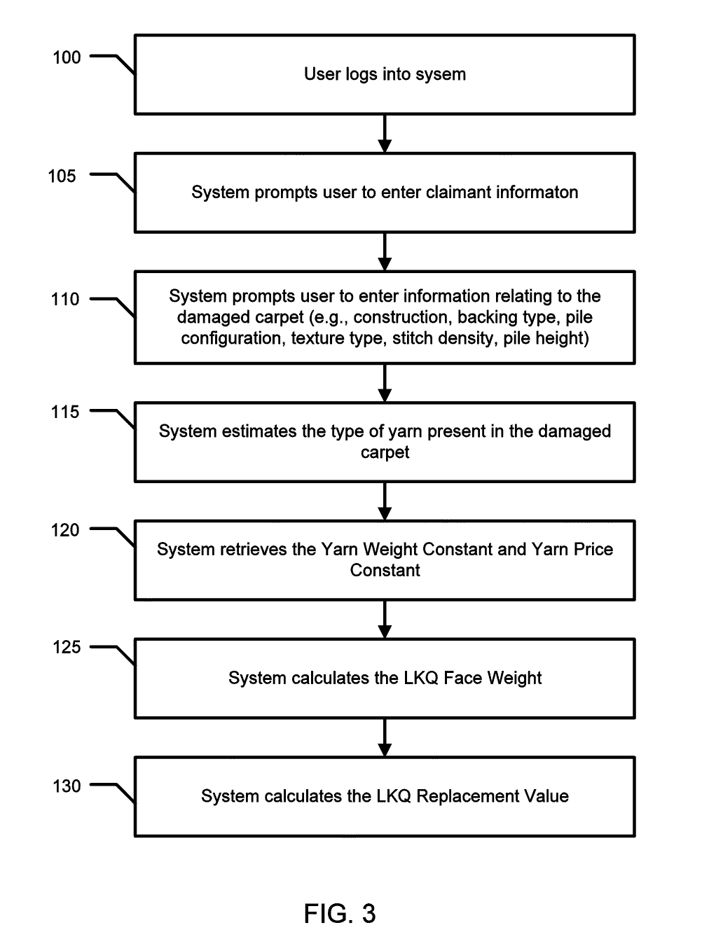

FIG. 3 illustrates the steps of a process for determining the LKQ replacement value and face weight of a damaged floor covering in accordance with an embodiment of the present invention. The process of calculating an LKQ replacement value and face weight begins at Step 100 with the user logging into the system. In various embodiments, the user is identified through a user name and password. The user may be an insurance adjuster, a restoration contractor or a flooring retailer.

At Step 105, the user may proceed with entering claimant information. This information may include the policyholder's name, insurance company, claim number, street address of the loss site, etc. After entering this basic information, the user may then perform a visual inspection of the damaged carpeting and initiate the estimation process.

At Step 110, the system prompts the user with a series of questions that build to a final identification of the carpet type for the damaged carpet. The first series of questions may relate to the construction type of the carpet. Generally, there are two different constructions of carpet—Tufted and Woven. Virtually all carpets are manufactured through one of these two processes, although approximately 90% are tufted. In some embodiments, the user is trained beforehand to visually identify the difference between tufted and woven carpets. In other embodiments, the reference folders include a tufted carpet swatch and a woven carpet swatch that may be used by the user to discern the damaged carpet's construction. In further embodiments, the Estimator System 10 may provide a display of the two types of carpet to assist the user in selecting the appropriate construction. In various embodiments, the Estimator System 10 displays the two choices for the user to select.

The next series of questions may relate to the backing of the damaged carpet. To identify the backing type, the user may refer to the carpet guide 20, which may provide swatches of the different types of backings. By sight and touch, the user matches the backing and selects the appropriate backing from a list of possible backing types provided by the system on the client computer 30. In various embodiments, the Estimator System 10 will only allow the user to select a backing type that would be appropriate for the construction type chosen. For example, woven products are only manufactured on specific backings. Therefore, if “woven” is chosen, only those backings that are specific to woven products may be displayed on the client computer 30 as possible selections.

The next series of questions may relate to the pile configuration of the carpet. For example, the user may be asked to determine whether the damaged carpet is a cut, loop or “cut and loop” style carpet. Virtually all carpet pile belongs to one of these three configurations. “Cut” pile indicates that the yarn is cut at the top of the pile during the manufacturing process resulting in a flat appearance. “Loop” pile indicates that the yarn is looped through the backing, and “Cut & Loop” is a manufacturing process that cuts some of the yarn while leaving others looped. This usually results in a patterned appearance. The user selects the configuration on the client computer 30 after making a visual inspection.

Next, the system may prompt the user to identify the texture type of the damaged carpet. In various embodiments, the user may be prompted to use to the carpet guide 20 to aid in identifying the appropriate texture type. Within each of the three configuration types, various subcategories (or texture types) may exist. The carpet guide 20 may include a representative sample of each texture type. The system will prompt the user to choose the texture type that most closely matches that of the damaged carpet and, as noted, the user may use the carpet guide 20 to aid in this determination. In various embodiments, the Estimator System 10 will only display those texture types that are specific to the selected pile configuration. For example, if the user selects a “cut” pile configuration, the system may only display textures associated with a cut pile carpet such as Cut Saxony, Cut Saxony Plush, Cut Shag, Cut Graphic, Cut Twist Frieze, and Cut Twist Frieze Cable.

The next series of questions may relate to the density of stitches within a unit area. In various embodiments, the user is instructed to count the number of stitches in one inch across the width of the carpet and then across the length of the carpet. In various embodiments, the system will only display the possible stitch counts that are consistent with the manufacturing process associated with the chosen pile configuration and texture type.

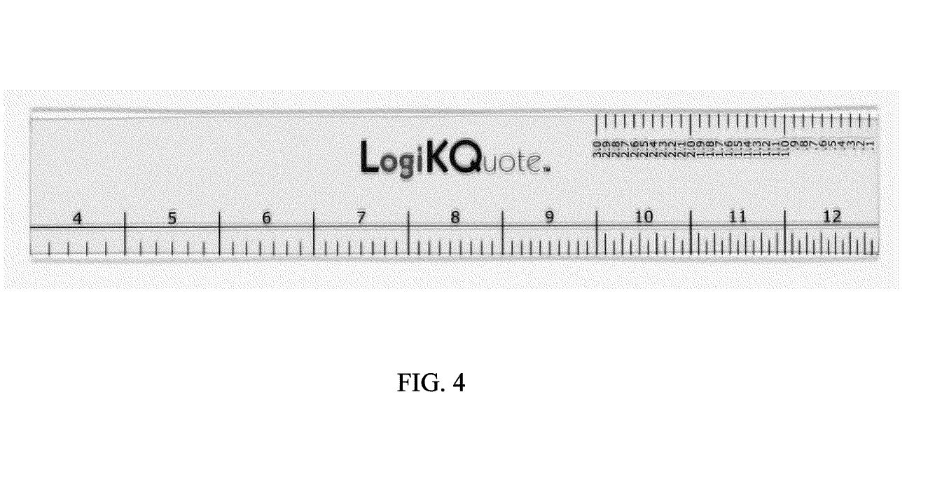

FIG. 4 illustrates a custom ruler that may be used with the Estimator System 10 to help the user identify the stitch count. The illustrated ruler includes a “tufts per inch” scale disposed along a longitudinal edge of the customer ruler. This scale includes major hash marks at one inch intervals. Between the major hash marks are minor hash marks indicating the associated tufts per inch from four tufts per inch up to twelve tufts per inch.

Next, the system may prompt the user to measure the pile height of the damaged carpet. In various embodiments, the user is prompted to measure the height of the pile of the subject carpet in tenths of an inch. In various embodiments, the Estimator System 10 will only display the possible pile heights that are consistent with the manufacturing process associated with the chosen pile configuration and texture type.

In various embodiments, the user may be instructed to use the custom ruler illustrated in FIG. 4 to measure the pile height. Opposite the tufts per inch scale, the illustrated custom ruler includes a pile height scale. This scale includes major hash marks at one inch intervals and minor hash marks at 0.1 inch intervals.

At Step 115, the system predicts the type of yarn fiber used in the damaged carpet based on the received information. Over 95% of all carpet is made of Nylon, Olefin or Polyester. In various embodiments, the system uses a probability analysis to identify the fiber type. For example, tufted cut-saxony carpets are made of Nylon 87.4% of the time with the remainder being Polyester. Because of the high probability that the damaged carpet is Nylon based on the type of carpet identified (i.e. tufted cut-saxony in this example), Nylon would be used in subsequent calculations.

In some embodiments, the system will prompt the user to send the carpet to a lab in the event the selection meets predetermined criteria. For example, wool is the most expensive fiber and only represents 2% of all carpets manufactured. If wool is identified as the carpet fiber based on the damaged carpet construction type and backing identified in the process, the system may advise the user to send a sample in for a detailed evaluation.

At Step 120, the Estimator System 10 uses the data entered by the user to query the relational database 45 and retrieve the Yarn Weight Constant and the Yarn Price Constant for the identified carpet type. In various embodiments, the Pricing Module 64 uses the carpet construction, backing style, pile configuration and texture type data gathered by the Estimator System 10 to query the relational database 45 to retrieve a Yarn Weight Constant and a Yarn Price Constant. These constants are then used to calculate the LKQ replacement value and face weight for the associated damaged carpet.

At Step 125, the Estimator System 10 calculates the LKQ face weight based on the determined Yarn Weight Constant and the stitch density and pile height of the damaged carpet. The LKQ face weight is calculated as follows:

Stitch Density=(Stitches per inch width)*(Stitches per inch length)*(1296 sq in/sqyd)

LKQ Face Weight=(Stitch Density)*(Pile Height)*(Yarn Weight Constant)

At Step 130, the Estimator System 10 calculates the LKQ replacement value based on the determined Yarn Price Constant as well as the stitch density and pile height of the damaged carpet. The LKQ replacement value is calculated as follows:

Base Wholesale Price per sq. yd.=(Stitch Density)*(Yarn Price Constant)*(Pile Height)

LKQ Replacement Value=(Base Wholesale Price)*(Typ. Retail Margin)

In various embodiments, the LKQ replacement value may also include a factor for shipping. Furthermore, the retail margin may vary according to geographic region and these various margins may be stored in the relational database 45 and retrieved during the calculation.

### Example

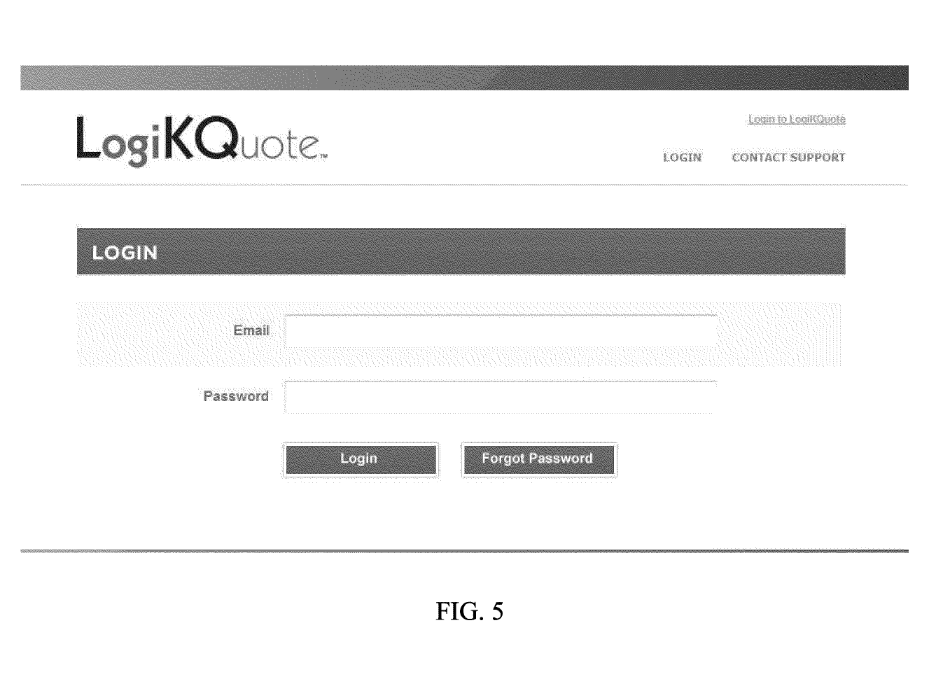

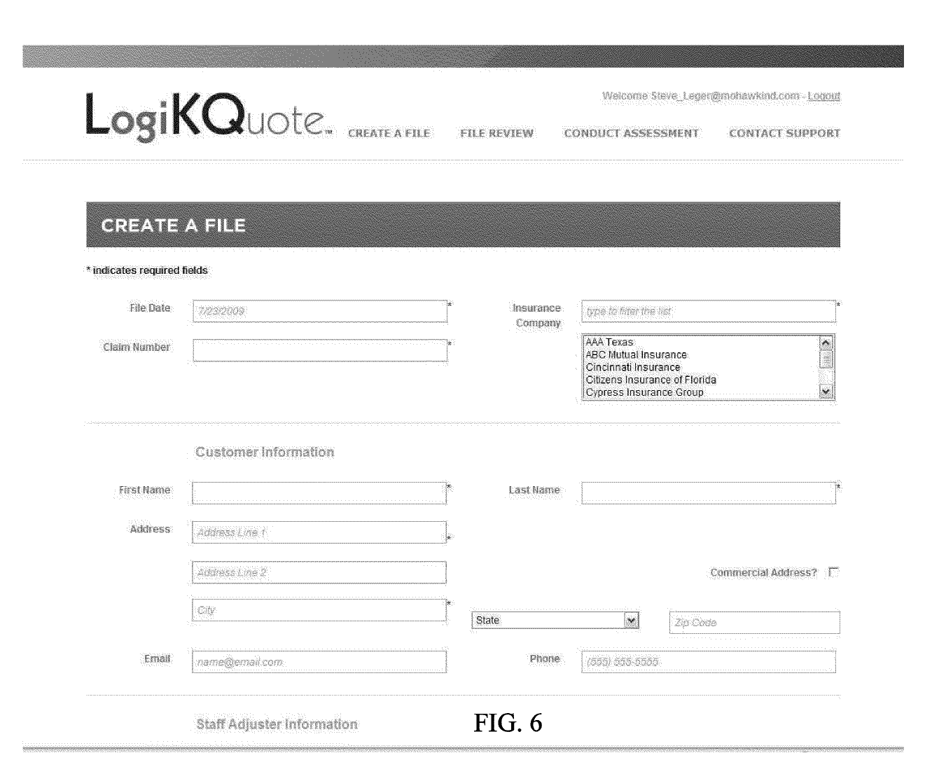

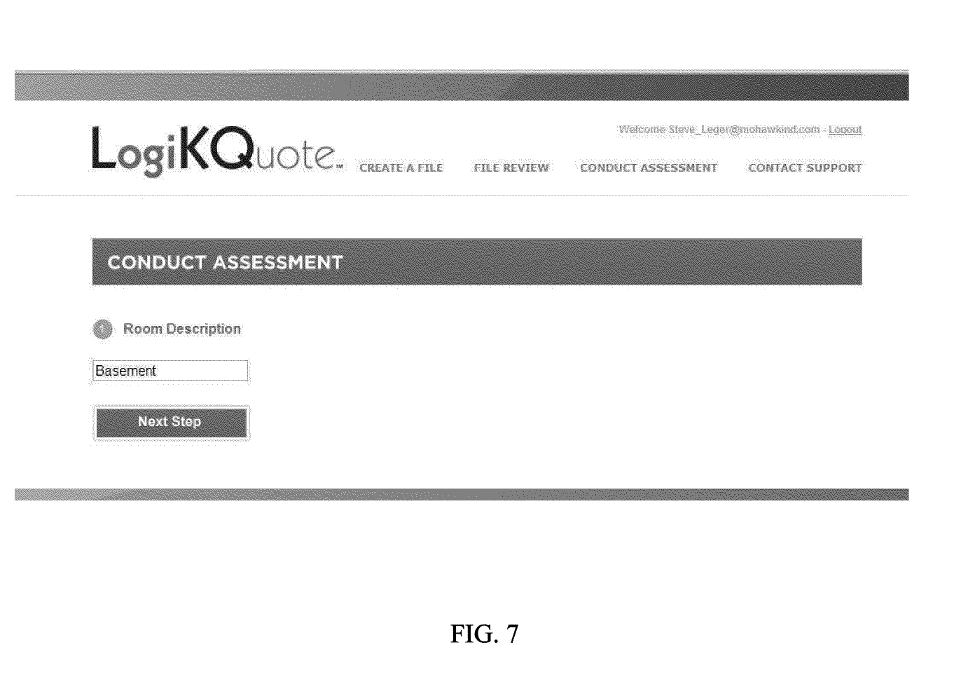

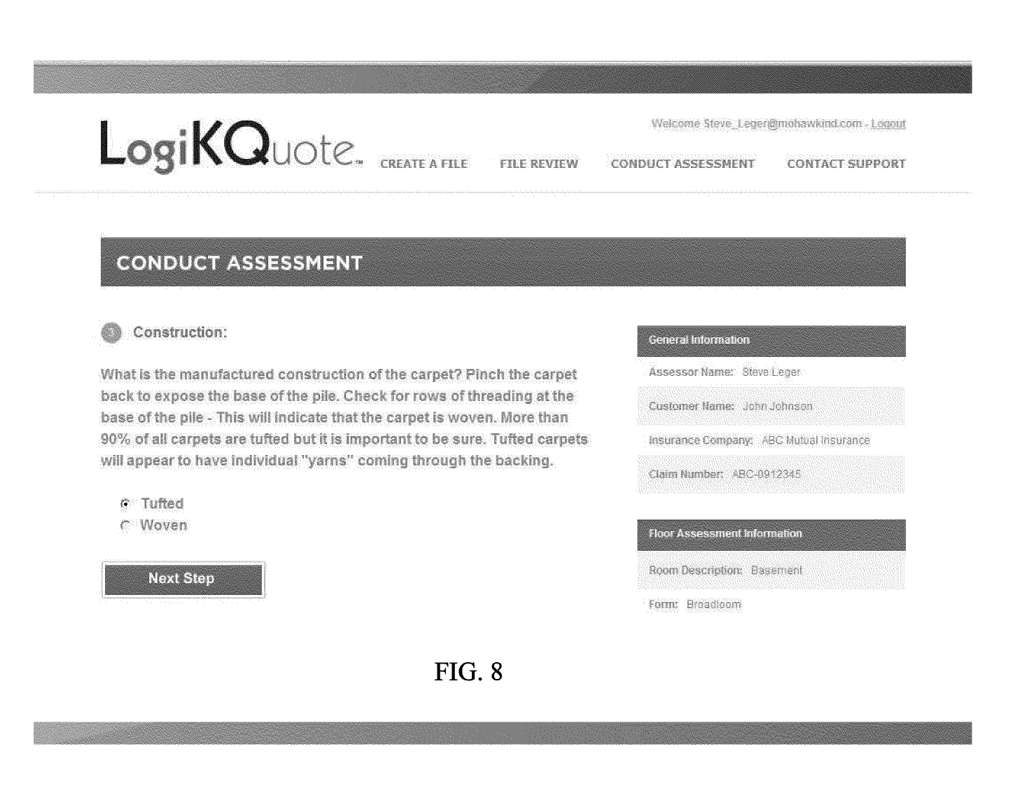

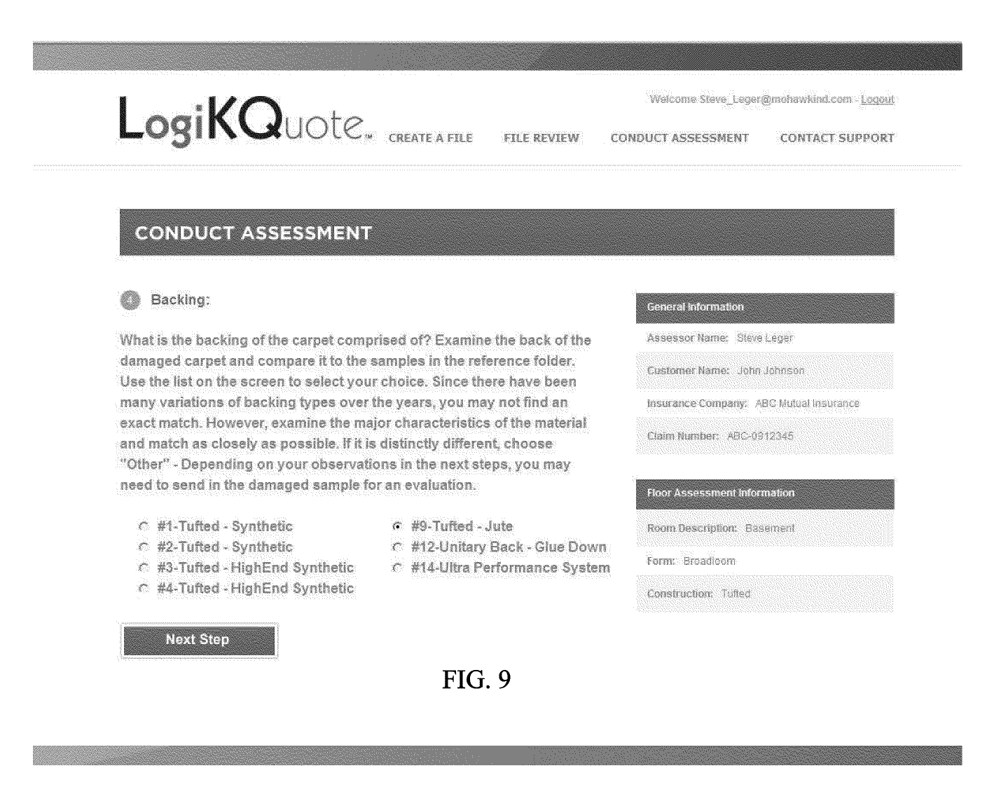

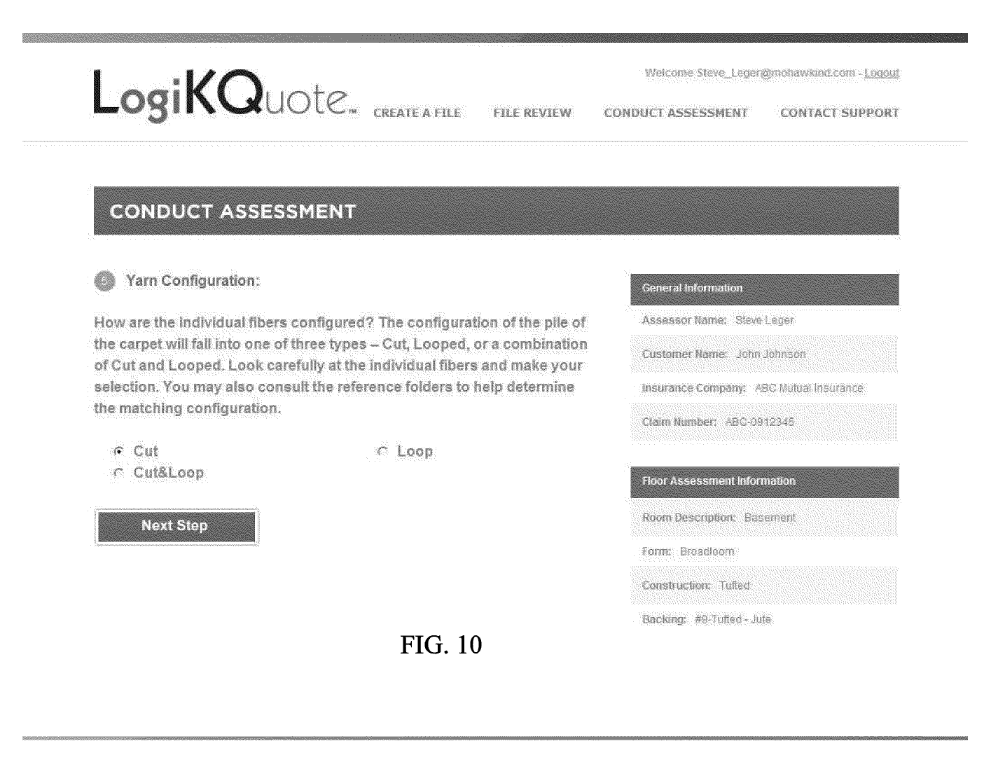

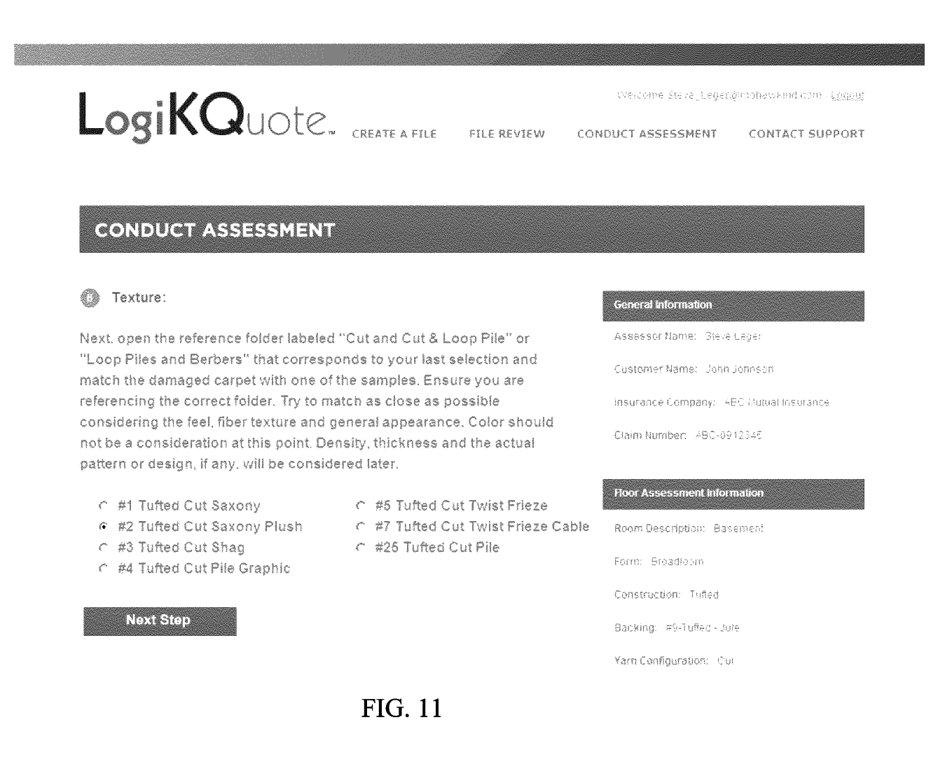

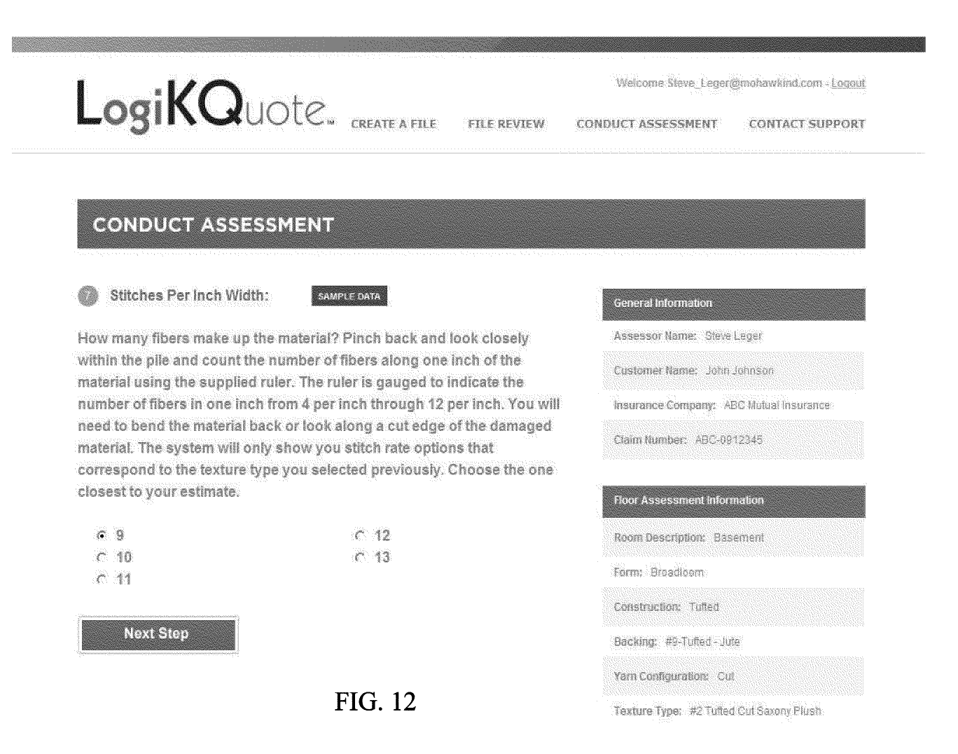

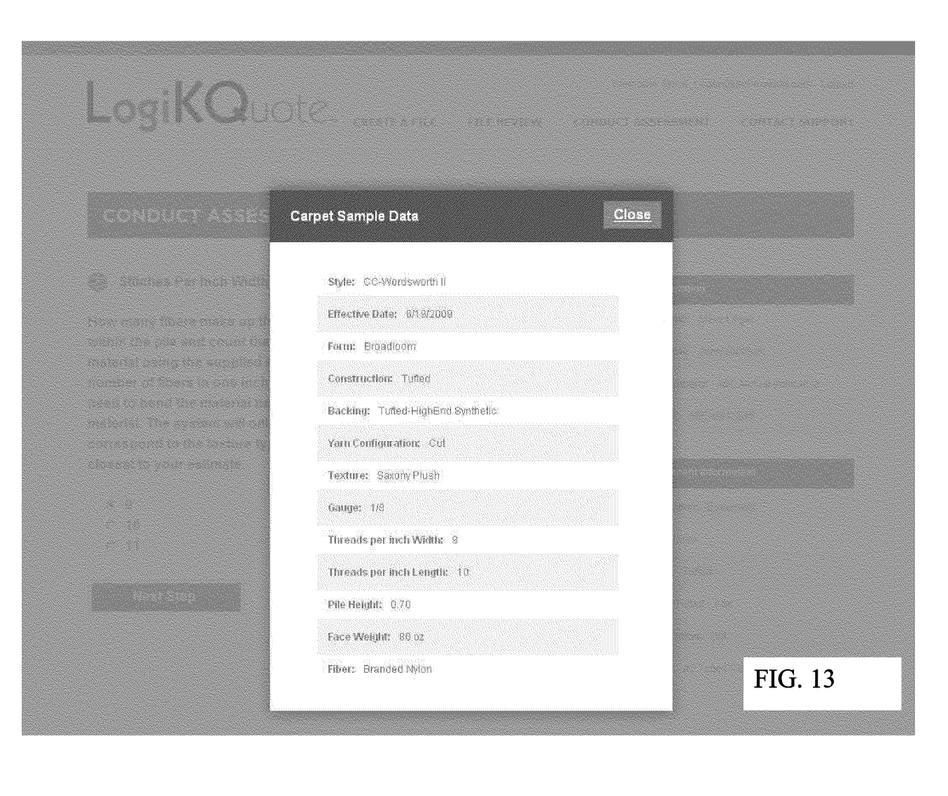

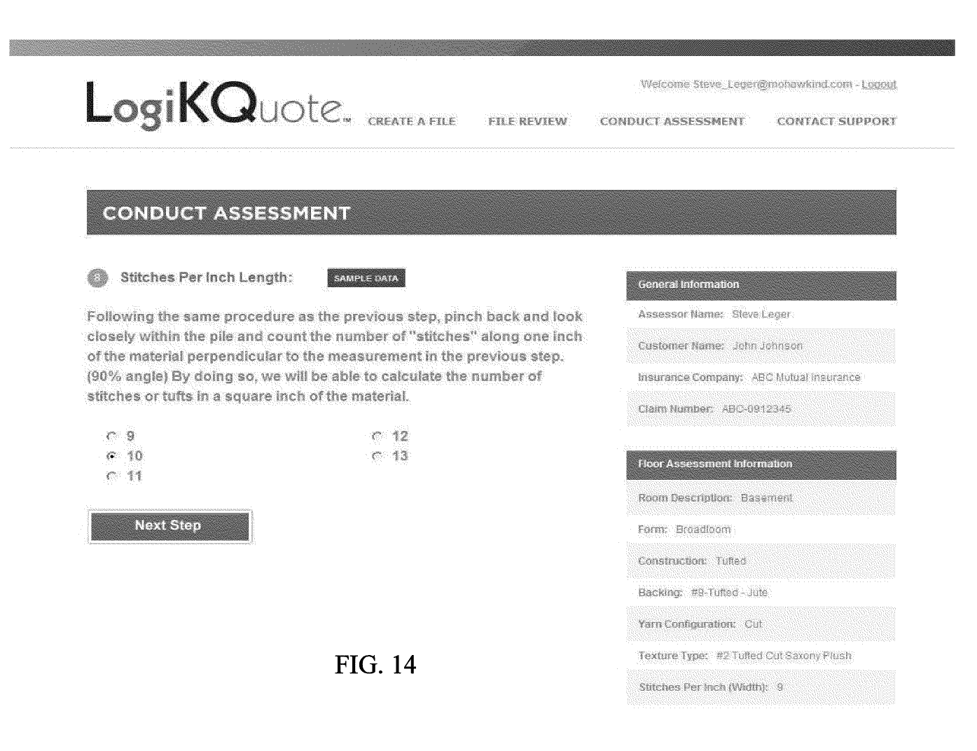

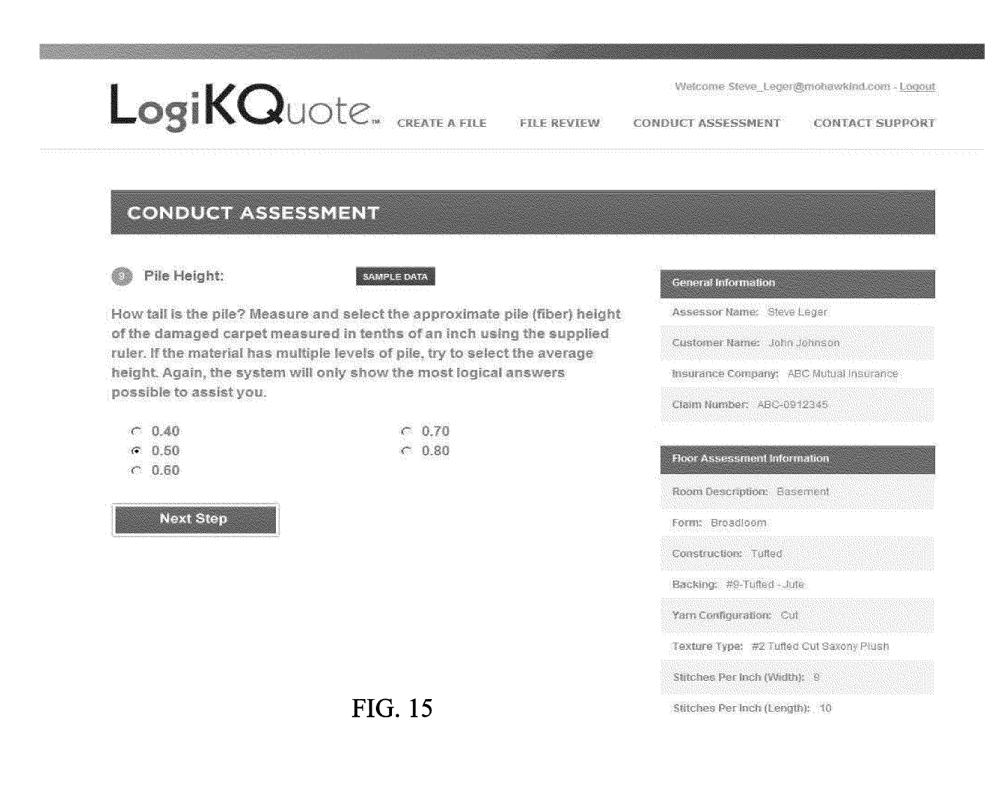

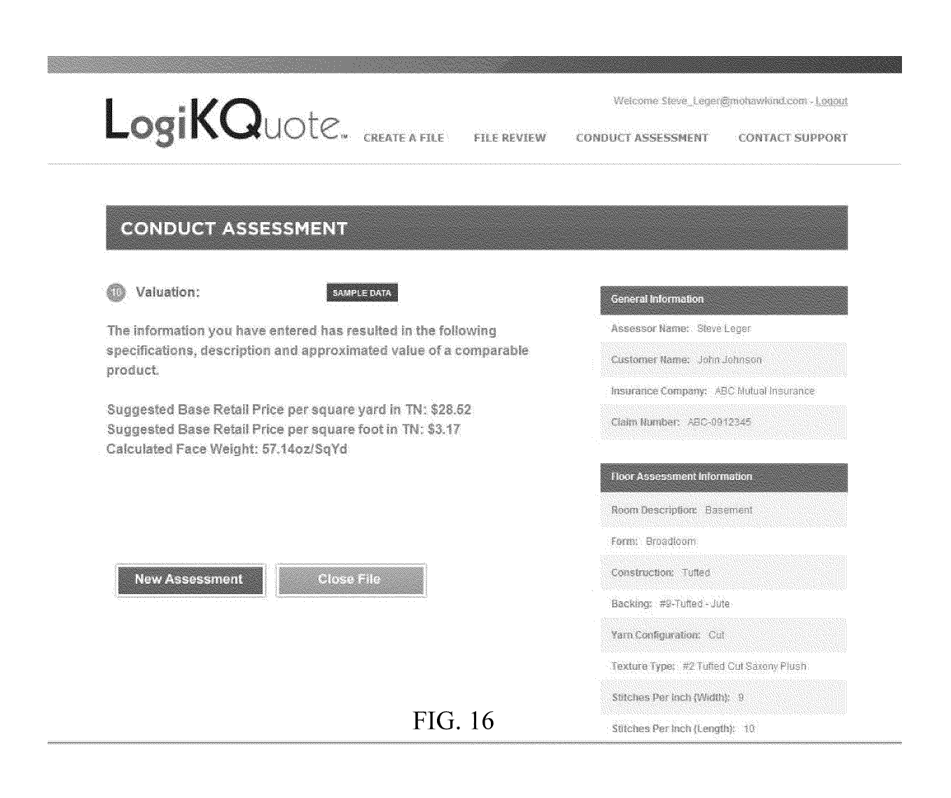

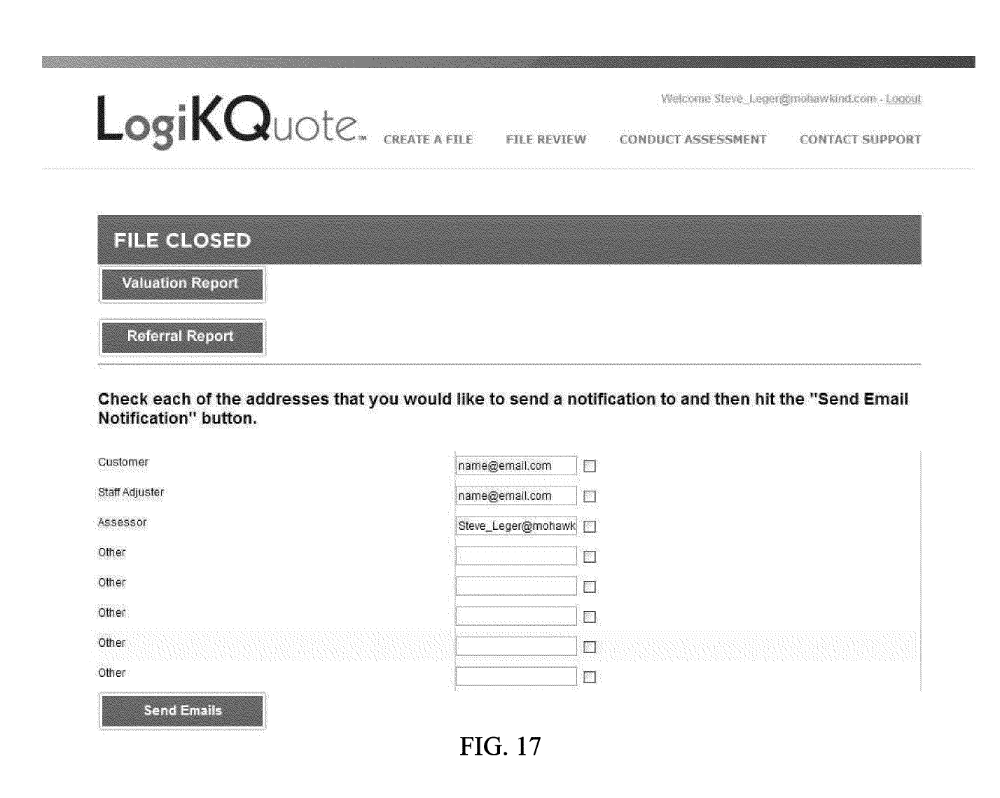

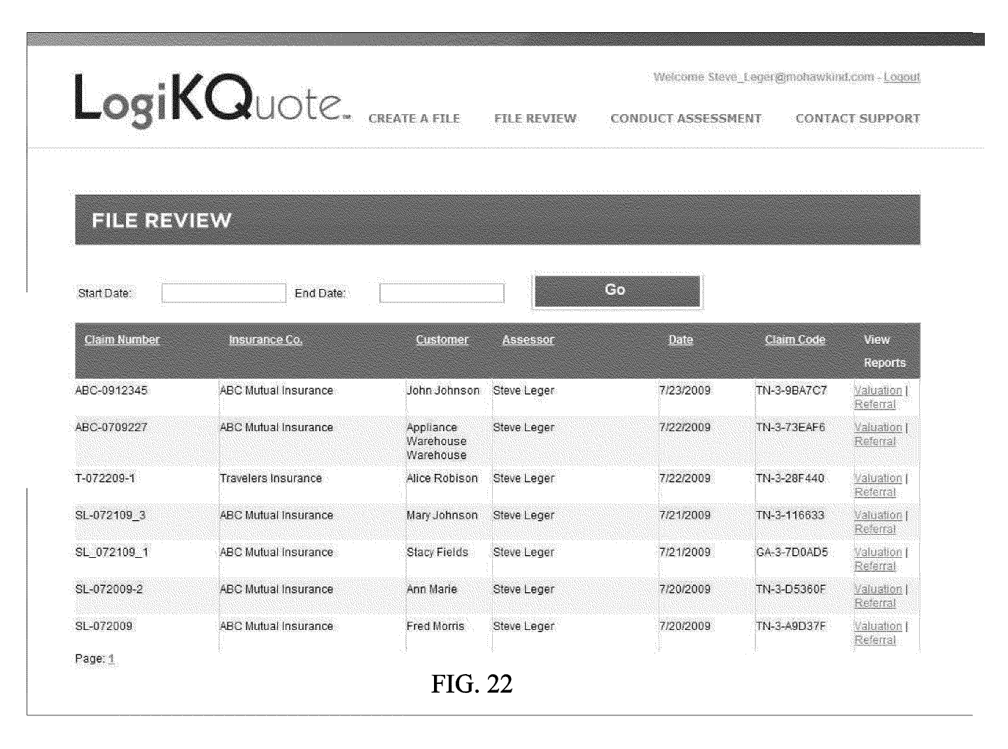

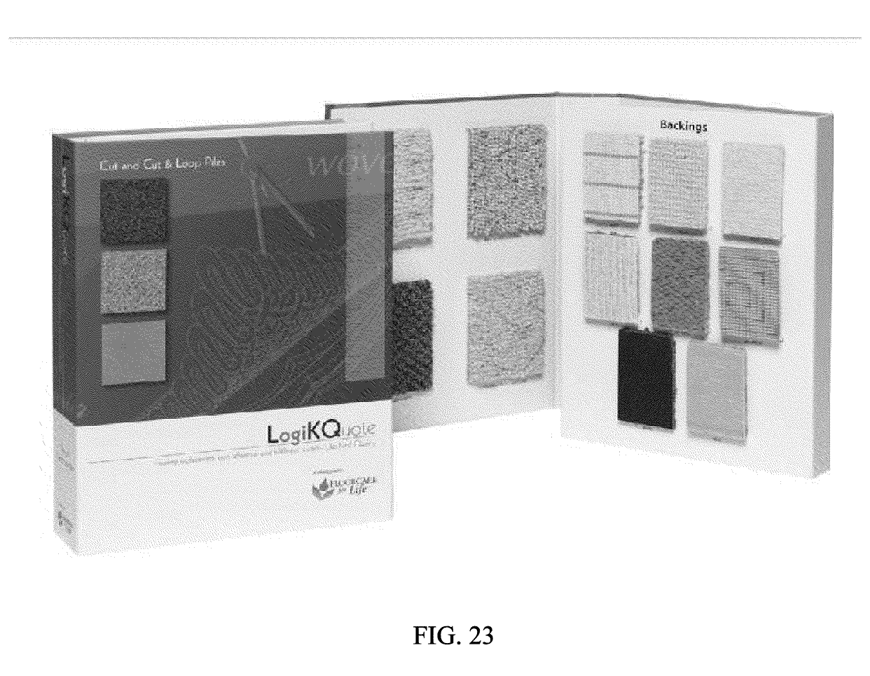

FIGS. 5-22 are screen shots depicting the steps followed by a user in determining the LKQ replacement value and face weight using an embodiment of the present invention. In this example, the Estimator System 10 prompts the user to enter various information relating to the damaged flooring and the entered data is summarized below.

Construction: Tufted

Backing: Synthetic

Configuration: Cut

Texture: Saxony

Stitches per inch/Width: 8

Stitches per inch/Length: 9

Pile height: 0.4

In this example, the Yarn Weight Constant and Yarn Price constant for the tufted cut-saxony carpet type retrieved from the relational database is 0.00055873427829874355 and 0.00033764378993837760. Using these constants, the system calculates the LKQ replacement value and face weight as follows.

8×9=72 stitches per square inch.

72×1296=93312 stitches per square yard

(93312×0.00055873427829874355)×0.4 PH=20.85 LKQ Face Weight(oz/sq. yd.)

(93312×0.00033764378993837760)×0.4 PH=$12.60/sq. yd. Base wholesale price

After obtaining a base wholesale price, the suggested retail price may be calculated. In this example, the retail margin is assumed to be 40%. The suggested retail price is calculated as follows:

$12.60×1.4=$18.76/sq.yd. LKQ Replacement Value

As noted above, a standard shipping rate may be added to the suggested retail price per square yard. The shipping rate may be a state specific shipping charge.

### CONCLUSION

The Estimator System 10 and associated methods described herein are unique and do not exist in the market today. One of the unique aspects of the Estimator system is the combination of physical reference samples coupled with the calculation logic of the programming designed for use at the actual site of the loss. As stated earlier, textile testing labs perform a mail-in service whereby a damaged flooring sample is subjected to a number of tests and measurements to ascertain fiber type, weight, the specific product name of the damaged carpet, and a list of actual retail styles that may match the damaged product. An issue arises when the style of the damaged carpet is no longer available.

The Estimator System 10 uses a mathematical model to calculate a result based on the actual specifications as measured by the system user. The mathematical modeling has several advantages over attempts to identify the specific product name of the damaged carpet. The Estimator System 10 may take any and all combinations of specifications into account regardless of whether there are no current retail styles on the market today to match. For example, a customer may have a damaged carpet that the insurance company has agreed to replace or cash-out at an LKQ replacement value. Assume the damaged carpet is determined to be a tufted cut shag that was purchased and installed over 20 years ago. A laboratory analysis will typically attempt to match the specifications to a database of products with similar specifications and use that match to report a suggested price. A problem arises when the match is no longer manufactured or available to purchase. Embodiments of the present invention resolve this problem by determining an LKQ replacement value based on a mathematical model that takes into account present day manufacturing costs to produce a similar product.

As described above and as will be appreciated by one skilled in the art, embodiments of the present invention may be configured as an apparatus, method, network entity and system. Accordingly, embodiments of the present invention may be assembled in various ways, including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented in various ways including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for calculating the LKQ replacement value for a damaged carpet comprising the steps of:
determining a yarn price constant for a plurality of carpet types, wherein the yarn price constant represents the price of a single tuft of yarn for a respective carpet type measured at a predetermined pile height;
receiving, from a user data relating to the damaged carpet's construction, and the damaged carpet's pile height and stitch density;
estimating, using a computing device, the yarn type of the damaged carpet based at least in part on the received data relating to the damaged carpet's construction;
querying a database, using the computing device, with at least a portion of the data received to retrieve an associated yarn price constant; and
calculating an LKQ replacement value, using a computing device, by multiplying the received damaged carpet's pile height and stitch density with the associated yarn price constant.

2. The method of claim 1, further comprising the steps of
determining a yarn weight constant for a plurality of carpet types, wherein the yarn weight constant represents the weight of a single tuft of yarn for a respective carpet type measured at a pile height of one inch;
querying a database with at least a portion of the data received to retrieve an associated yarn weight constant; and
calculating an LKQ face weight by multiplying the received damaged carpet's pile height and stitch density with the associated yarn weight constant.

3. A flooring cost estimator system comprising:
one or more processors in communication with one or more data storage devices, wherein the one or more processors programmed to:
determine a yarn price constant for a plurality of carpet types, wherein the yarn price constant represents the price of a single tuft of yarn for a respective carpet type measured at a predetermined pile height;
receive, from a user data relating to the damaged carpet's construction, and the damaged carpet's pile height and stitch density;
estimate the yarn type of the damaged carpet based at least in part on the received data relating to the damaged carpet's construction;
query the one or more data storage devices with at least a portion of the data received to retrieve an associated yarn price constant; and
calculate an LKQ replacement value, using a computing device, by multiplying the received damaged carpet's pile height and stitch density with the associated yarn price constant.
